(19) United States
(12) Patent Application Publication
(10) Pub. No.: US 2015/0200876 A1
(43) Pub. Date: Jul. 16, 2015

(54) COMPUTER ECOSYSTEM WITH CONTEXT-SPECIFIC RESPONSES

(71) Applicant: SONY CORPORATION, Tokyo (JP)

(72) Inventor: STEVEN MARTIN RICHMAN, San Diego, CA (US)

(73) Assignee: SONY CORPORATION, Tokyo (JP)

(21) Appl. No.: 14/157,214

(22) Filed: Jan. 16, 2014

(51) Int. Cl. H04L 12/58

(52) U.S. Cl. CPC H04L 51/02

(57) ABSTRACT

An attempt to contact a recipient while the recipient is engaged in a media event is received from a sender, and an importance of the attempt to contact is determined. Based at least in part on the importance of the attempt to contact, a reply message indicating an activity of the recipient is automatically sent to the sender.

### I. FIELD OF THE INVENTION

The present application relates generally to computer ecosystems and more particularly to context-specific messaging.

### II. BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity for novel innovations and adaptations to changing demands.

Present principles are directed to specific aspects of computer ecosystems, specifically, tailoring computer behavior in an ecosystem to user context. As understood herein, with the multitude of network connected personal devices being used and simultaneous applications running on them, an increasing number of people find themselves being interrupted in situations where they need privacy or when they only want certain types of interruptions to occur or information to be presented to them for consideration. Several attempts at communication or may contend for attention at a single point in time.

Similarly, present principles understand that while consuming media, the viewer is constantly presented with possible interruptions of the entertainment experience.

### SUMMARY OF THE INVENTION

With the above recognitions in mind, present principles recognize the desirability of establishing a level or framework that can be used for deciding if information should be allowed to be received or sent in the first place. In some examples, present principles recognize that although the consumer can choose to respond to or answer the attempt to contact the consumer, often the consumer wishes to block the phone call, instant message, email, pop-up advertisement and respond automatically to the attempt to contact. In these examples, this automated response may be sent back to the person making the contact to inform them intelligently of when they are likely to get a response, not just that the consumer who is being entertained is unavailable.

A device includes at least one computer readable storage medium bearing instructions executable by a processor, and at least one processor configured for accessing the computer readable storage medium to execute the instructions to configure the processor for receiving from a sender an attempt to contact a recipient while the recipient is engaged in a media event. The processor is configured for determining an importance of the attempt to contact, and based at least in part on the importance of the attempt to contact, automatically sending to the sender a reply message indicating an activity of the recipient.

In some examples, the processor when executing the instructions is further configured for determining a type of media event the recipient is experiencing and based at least in part on the type of media event, establishing the reply message. The reply message may indicate a title of the media event and/or an estimated time the recipient will contact the sender.

In example implementations, the processor when executing the instructions is further configured for analyzing content of the media event to return at least a title of the media event and a time period left remaining to an end of the media event. Content of the reply message apart from a device identification can be generated depending on the sender to personalize the reply message based upon the media event and the importance of the attempt to contact. The processor when executing the instructions may be configured for determining the importance of the attempt to contact by comparing sender ID information to user-defined parameters.

In another aspect, a method includes presenting on a display a user interface (UI) enabling a user to correlate an importance to a sender. The UI has a first column of senders and at least first and second importance selectors selectable by the user to correlate a first importance or a second importance, respectively, to senders in the first column.

In another aspect, a system includes at least one computer readable storage medium bearing instructions executable by a processor which is configured for accessing the computer readable storage medium to execute the instructions to configure the processor for presenting on a display a user interface (UI) enabling a user to tailor automatic replies to attempted contacts by senders by sender importance. The UI includes plural importance category indicators indicating respective importances of respective senders, and plural message parameter selectors including a first selector allowing a user to select whether to return any response at all for one or more importances, and at least a second selector allowing a user to select whether to send a media name or type in a response to a sender in a correlated importance category so that the sender knows what the user is watching.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a flowchart of example overall logic;

FIG. 3 is a flow chart of example specific logic for establishing a temporary state profile for sharing or filtering;

FIG. 4 is a screen shot of an example user interface (UI) related to FIGS. 2 and 3;

FIG. 5 is flowchart of example additional overall logic; and

FIGS. 6 and 7 are screen shots of an example UIs related to the logic shown in FIG. 5.

### DETAILED DESCRIPTION OF THE PREFERRED EMBODIMENT

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

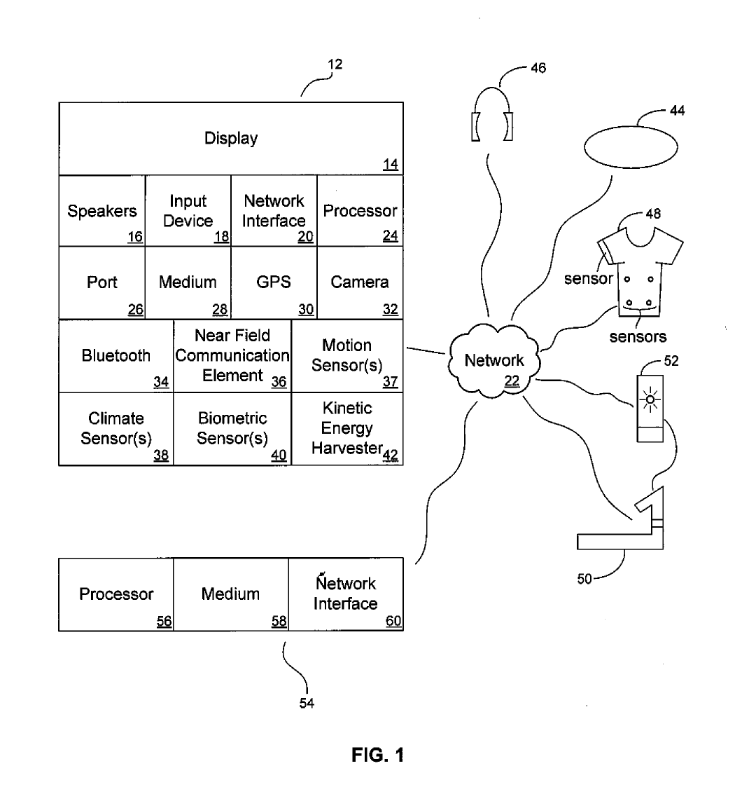

Now specifically referring to FIG. 1, an example system 10 is shown, which may include one or more of the example devices mentioned above and described further below in accordance with present principles. The first of the example devices included in the system 10 is an example consumer electronics (CE) device 12 that may be waterproof (e.g., for use while swimming). The CE device 12 may be, e.g., a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc., and even e.g. a computerized Internet-enabled television (TV). Regardless, it is to be understood that the CE device 12 is configured to undertake present principles (e.g. communicate with other CE devices to undertake present principles, execute the logic described herein, and perform any other functions and/or operations described herein).

Accordingly, to undertake such principles the CE device 12 can be established by some or all of the components shown in FIG. 1. For example, the CE device 12 can include one or more touch-enabled displays 14, one or more speakers 16 for outputting audio in accordance with present principles, and at least one additional input device 18 such as e.g. an audio receiver/microphone for e.g. entering audible commands to the CE device 12 to control the CE device 12. The example CE device 12 may also include one or more network interfaces 20 for communication over at least one network 22 such as the Internet, an WAN, an LAN, etc. under control of one or more processors 24. It is to be understood that the processor 24 controls the CE device 12 to undertake present principles, including the other elements of the CE device 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, WiFi transceiver, etc.

In addition to the foregoing, the CE device 12 may also include one or more input ports 26 such as, e.g., a USB port to physically connect (e.g. using a wired connection) to another CE device and/or a headphone port to connect headphones to the CE device 12 for presentation of audio from the CE device 12 to a user through the headphones. The CE device 12 may further include one or more tangible computer readable storage medium 28 such as disk-based or solid state storage, it being understood that the computer readable storage medium 28 may not be a carrier wave. Also in some embodiments, the CE device 12 can include a position or location receiver such as but not limited to a GPS receiver and/or altimeter 30 that is configured to e.g. receive geographic position information from at least one satellite and provide the information to the processor 24 and/or determine an altitude at which the CE device 12 is disposed in conjunction with the processor 24. However, it is to be understood that that another suitable position receiver other than a GPS receiver and/or altimeter may be used in accordance with present principles to e.g. determine the location of the CE device 12 in e.g. all three dimensions.

Continuing the description of the CE device 12, in some embodiments the CE device 12 may include one or more cameras 32 that may be, e.g., a thermal imaging camera, a digital camera such as a webcam, and/or a camera integrated into the CE device 12 and controllable by the processor 24 to gather pictures/images and/or video in accordance with present principles. Also included on the CE device 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the CE device 12 may include one or more motion sensors 37 (e.g., an accelerometer, gyroscope, cyclometer, magnetic sensor, infrared (IR) motion sensors such as passive IR sensors, an optical sensor, a speed and/or cadence sensor, a gesture sensor (e.g. for sensing gesture command), etc.) providing input to the processor 24. The CE device 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that in some embodiments the CE device 12 may also include a kinetic energy harvester 42 to e.g. charge a battery (not shown) powering the CE device 12.

Still referring to FIG. 1, in addition to the CE device 12, the system 10 may include one or more other CE device types such as, but not limited to, a computerized Internet-enabled bracelet 44, computerized Internet-enabled headphones and/or ear buds 46, computerized Internet-enabled clothing 48, a computerized Internet-enabled exercise machine 50 (e.g. a treadmill, exercise bike, elliptical machine, etc.), etc. Also shown is a computerized Internet-enabled entry kiosk 52 permitting authorized entry to a space. It is to be understood that other CE devices included in the system 10 including those described in this paragraph may respectively include some or all of the various components described above in reference to the CE device 12 such but not limited to e.g. the biometric sensors and motion sensors described above, as well as the position receivers, cameras, input devices, and speakers also described above.

Now in reference to the afore-mentioned at least one server 54, it includes at least one processor 56, at least one tangible computer readable storage medium 58 that may not be a carrier wave such as disk-based or solid state storage, and at least one network interface 60 that, under control of the processor 56, allows for communication with the other CE devices of FIG. 1 over the network 22, and indeed may facilitate communication between servers and client devices in accordance with present principles. Note that the network interface 60 may be, e.g., a wired or wireless modem or router, WiFi transceiver, or other appropriate interface such as, e.g., a wireless telephony transceiver.

Accordingly, in some embodiments the server 54 may be an Internet server, may include and perform “cloud” functions such that the CE devices of the system 10 may access a “cloud” environment via the server 54 in example embodiments.

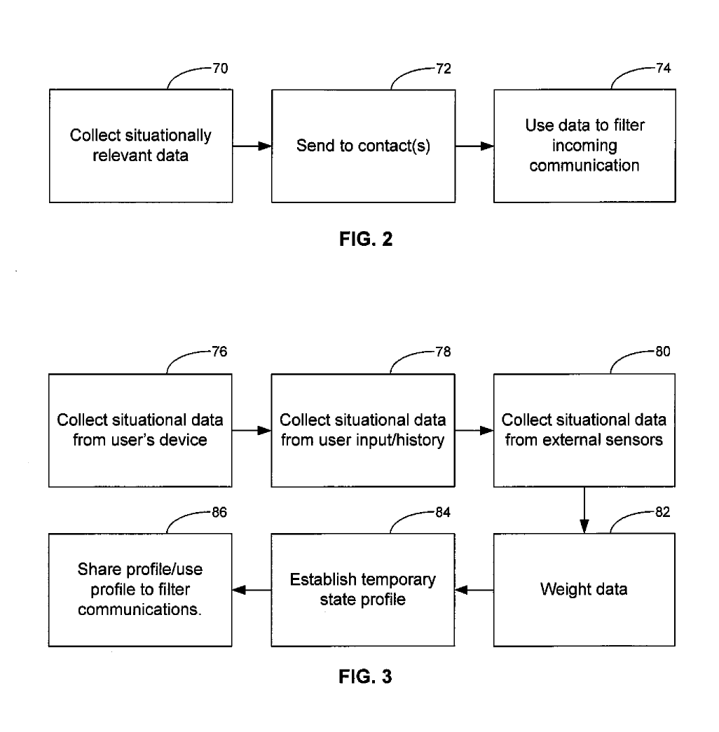

Now referring to FIG. 2, which shows logic that may be implemented by any of the processors above alone or in combination, an overall method is disclosed to give a user of a device the ability to have situational relevant information sent to people who may wish to contact them, or to block irrelevant data or contact from being received that would be disruptive given a particular context or situation. In order to more accurately determine the appropriateness of communication, the situation of an intended recipient, or the state of a user's activity, information is gathered at block 70 and sent at block 72 to external devices or people intending to make contact to inform the external devices/people of the recipient's situation, such that the external devices/people can decide to continue with contact or withhold contact. The purpose of collecting this information is to establish a context which can be shared, sent, accessed remotely, or serve as a filter itself at block 74 for different types of content or communication that is being sent or considered by the receiving device or person.

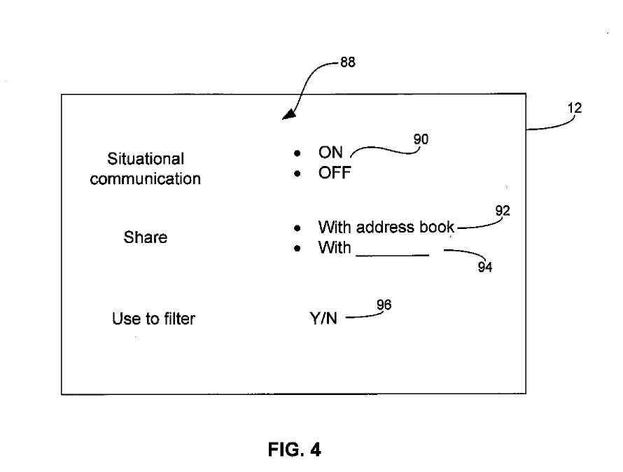

The principles outlined above can be further appreciated in greater detail in reference to FIG. 3. To establish context or situational relevant communication, data points are collected from the device itself at block 76, from the user by means of an input device at block 78 (which may also include accessing historical data), and from external sensors at block 80, such as any of the sensors shown in FIG. 1. The data may be weighted at block 82 and then a temporary state profile of the user created at block 84, based on the weighted data. The temporary-state profile include various forms such as a graphical picture, a color, or a formatted file, or icon that houses each representational element. These elements can be made up of identifiers of state such as location of device, current time, mobility rate, description of surroundings, temperature, activity level, priority level, etc. As alluded to above, some of these identifiers are automatically set and some of them can be input by the user to create the overall state profile. This profile can then be shared with others or used to filter content or communication at block 86.

As an example, situational data that can be collected from the user's device at block 76 may include location of the device as indicated by the GPS sensor 30, mobility rate (rate of motion of the device), again as indicated by the GPS sensor, and other data including visual depictions of the user's surroundings as indicated by images from the camera 32, perhaps with descriptive metadata of the images as output by an image recognition algorithm. The user may manually enter a description of his or her surroundings, e.g., “in living room”. Temperature may be received (block 80) from a temperature sensor 38, and biometric information may be received from the biometric sensor 40. Activity level and priority level may be received (block 78) by user manual input. Manually entered data may be given higher weight than device detected data, which may in turn be given higher weight than external sensor data. Or, manually entered data may be given lower weight than device detected data, which may in turn be given higher weight than external sensor data. Or, manually entered data may be given higher weight than device detected data, which may in turn be given lower weight than external sensor data. Or, manually entered data may be given lower weight than device detected data, which may in turn be given lower weight than external sensor data.

FIG. 4 shows a UI 88 that is related to the logic shown in FIGS. 2 and 3 and that can be presented on the user's CE device 12. As indicated at 90, the user can select to turn the features of FIGS. 2 and 3 on and off. The collected data which constitutes the temporary state profile may be selected at 92 by the user to be shared with the user's entire address book, or only with specific people using input element 94. The user can select at 96 whether to further use the profile to filter incoming communications, examples of which are set forth more fully below. Other options and combination are contemplated herein. The device in turn automatically sends the temporary profile to the selected users (typically by sending the information to the network addresses of devices associated with the selected users) via wired or wireless transmission. By sharing the user's temporary situation profile, other users can know whether it is an opportune time to contact the sharing user, how best to contact the sharing user, and in general tailor their conduct toward the sharing user as appropriate for the user's temporary profile.

For example, suppose the device 12 detected that it was moving at a speed indicating vehicle travel, e.g., greater than 20 miles per hour. Suppose further that the device 12 includes a calendar indicating that the user has a meeting 20 minutes in the future. The device 12 might automatically inform people per the user's settings input by the UI 88 that “User is driving to meeting and cannot be contacted, expect to be available in 20 minutes.”

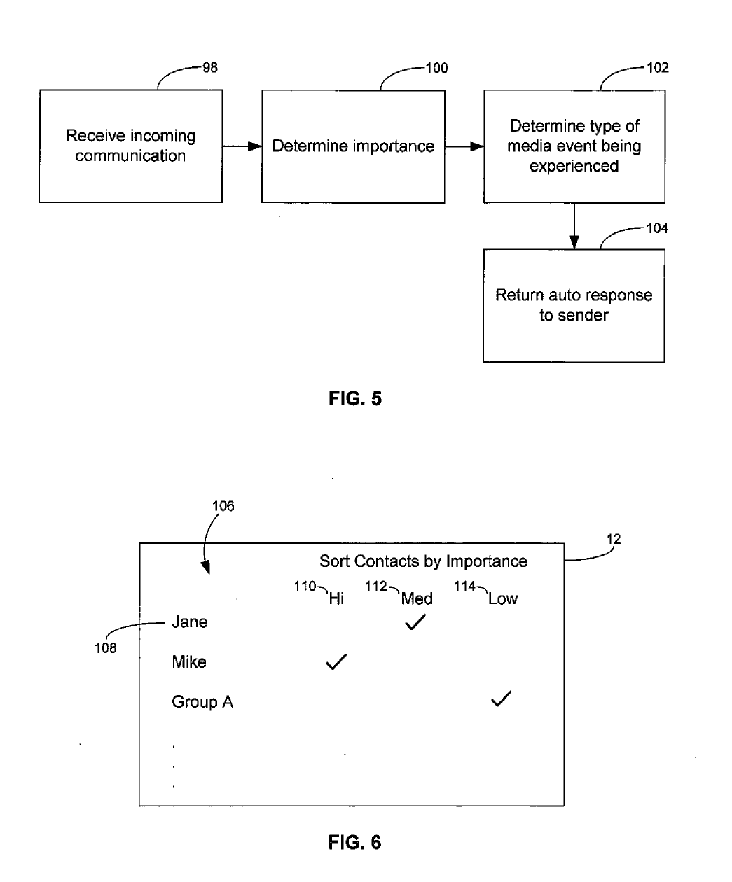

FIGS. 5-7 relatedly show divulge an intelligent reply system that receives at block 98 in FIG. 5 an attempt to contact a user (a “recipient”) such as a consumer while being entertained, and then at block 100 determines the level of importance of the contact attempt at block 98. The type of media event the recipient is experiencing is determined at block 102, and then at block 104 a personal or intelligent message of FIG. 5 automatically is sent back to the person attempting the contact (“sender”) that gives the sender more information about when he will be contacted by the recipient in return, or what is currently happening in the recipient's experience. An example is if a family member is watching a movie, and, if the caller is another family member, the message back to the caller might be that “we are watching [movie title] and it will be over at [time] and we will call you back then.” This gives the caller/sender much more information about what is going on at the moment for other family members.

In greater specificity, the context of the media being consumed may be recorded in real time (by, e.g., the CE device 12 using its camera 32 and microphone input device 18) using a combination of real-time audio and video fingerprinting analysis executed by the CE device processor and/or a cloud server and comparison with a storage database of media metadata (such as Gracenote). This data can then be analyzed in real-time for such things as the title of the media and time left remaining to the end of the media event, a reply message composed depending on the device that is sending the message. The reply message uses software heuristics to personalize the reply message based upon the media being watched or consumed, the importance of the media session (i.e. family gathering), and the importance of the attempted contact being made. Then a real-time response using heuristics pre-selected by the consumer is sent personalizing how certain people are to be responded to. The importance of the contact can be captured by comparing sender ID information such as a phone number, email address, instant message ID, or content of the sender's message stored on the device and then comparing it to user-defined weighting parameters. These parameters can be based on time of day, categories of people making contact (i.e. work, family, friends, neighbors, business), and mood indicators controlled by the consumer for that particular media session (in effect, a “do not disturb” sign).

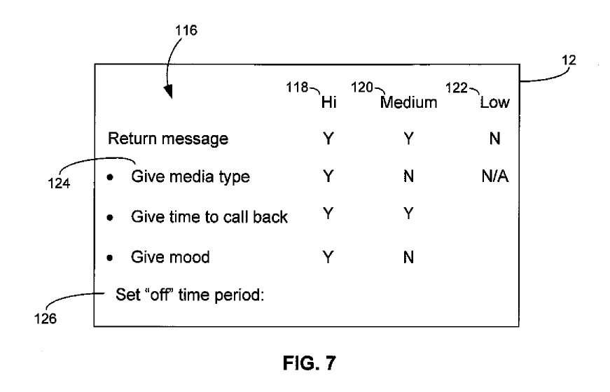

FIGS. 6 and 7 illustrate examples of the above principles. A UI 106 is shown in FIG. 6 by use of which a user of a CE device such as the CE device 12 can sort contacts in a column 108 and designate each contact, which can be an individual or a group, as high importance contact 110, medium importance 112, and low importance 114, using, for example, check marks as shown.

Then, a UI 116 can be presented on the CE device allowing a user to tailor automatic responses to attempted contacts by sender importance type. In the example shown, messages can be tailored by sender category high 118, medium 120, and low 122 for each of a plurality of automatic response message parameters in a column 124. Example parameters include whether to return any response at all, in the example shown, “yes” for high and medium importance senders and “no” for low importance senders. The parameters can also include whether to send the media name or type in the response so that the sender knows what the recipient is watching, in the example shown, only in the case of high importance senders. The parameters may include whether to include a time at which the recipient expects to be available to return the attempted contact, e.g., at the end of the media event as determined as described above, in the example shown, “yes” for both categories (high a medium importance senders) for which automatic responses are to be generated. A “mood” of the recipient may also be included in the response, in the example shown, only for high importance senders.

To detect the mood of the recipient, the client device may receive manual user input indicating mood, e.g., “happy” or “sad”. Or, the client device may receive information from a sensor such as a biometric sensor shown in FIG. 1 with physical parameters of the person being sensed being correlated to mood. High temperature and pulse rate, for example, can be correlated to “excited”; the opposite may be correlated to “relaxed”.

At entry element 126 the user may also set an “off” time period during which no responses at all are returned to senders of attempted contacts.

While the particular COMPUTER ECOSYSTEM WITH CONTEXT-SPECIFIC RESPONSES is herein shown and described in detail, it is to be understood that the subject matter which is encompassed by the present invention is limited only by the claims.

What is claimed is:

1. A device comprising:
at least one computer readable storage medium bearing instructions executable by a processor;
at least one processor configured for accessing the computer readable storage medium to execute the instructions to configure the processor for:
receiving from a sender an attempt to contact a recipient while the recipient is engaged in a media event;
determining an importance of the attempt to contact; and
based at least in part on the importance of the attempt to contact, automatically sending to the sender a reply message indicating an activity of the recipient.

2. The device of claim 1, wherein the processor when executing the instructions is further configured for determining a type of media event the recipient is experiencing and based at least in part on the type of media event, establishing the reply message.

3. The device of claim 1, wherein the reply message indicating an activity of the recipient indicates a title of the media event.

4. The device of claim 1, wherein the reply message indicating an activity of the recipient indicates an estimated time the recipient will contact the sender.

5. The device of claim 1, wherein the processor when executing the instructions is further configured for analyzing content of the media event to return at least a title of the media event and a time period left remaining to an end of the media event.

6. The device of claim 1, wherein content of the reply message apart from a device identification is generated depending on the sender to personalize the reply message based upon the media event and the importance of the attempt to contact.

7. The device of claim 6, wherein the processor when executing the instructions is configured for determining the importance of the attempt to contact by comparing sender ID information to user-defined parameters.

8. Method comprising:
presenting on a display a user interface (UI) enabling a user to correlate an importance to a sender, the UI comprising:
a first column of senders; and
at least first and second importance selectors selectable by the user to correlate a first importance or a second importance, respectively, to senders in the first column.

9. The method of claim 8, wherein the UI includes a third importance selector selectable by a user to correlate a third importance to one or more senders in the first column.

10. The method of claim 8, wherein at least single first sender in the first column represents a group of senders.

11. The method of claim 8, comprising automatically sending a reply to a first sender in the first column in response to a message from the first sender at least in part based on the importance correlated to the first sender.

12. The method of claim 8, comprising:
receiving from a first sender in the first column an attempt to contact a recipient while the recipient is engaged in a media event;
determining an importance of the attempt to contact; and
based at least in part on the importance of the attempt to contact, automatically sending to the first sender a reply message indicating an activity of the recipient at least in part based on the importance correlated to the first sender.

13. The method of claim 12, comprising determining a type of media event the recipient is experiencing and based at least in part on the type of media event, establishing the reply message.

14. The method of claim 11, wherein the reply message indicates an activity of the recipient indicates a title of the media event.

15. System comprising:
at least one computer readable storage medium bearing instructions executable by a processor which is configured for accessing the computer readable storage medium to execute the instructions to configure the processor for:
presenting on a display a user interface (UI) enabling a user to tailor automatic replies to attempted contacts by senders by sender importance, the UI comprising:
plural importance category indicators indicating respective importances of respective senders;
plural message parameter selectors including a first selector allowing a user to select whether to return any response at all for one or more importances, and at least a second selector allowing a user to select whether to send a media name or type in a response to a sender in a correlated importance category so that the sender knows what the user is watching.

16. The system of claim 15, wherein the UI includes a third selector allowing a user to select whether to include a time in the reply at which the user expects to be available to return an attempted contact from a sender.

17. The system of claim 15, wherein the instructions further configure the processor for:
receiving from a sender an attempt to contact a recipient while the recipient is engaged in a media event, the recipient being the user;
determining an importance of the attempt to contact; and
based at least in part on the importance of the attempt to contact, automatically sending to the sender a reply based at least in part on user selections input via the UI indicating an activity of the recipient.

18. The system of claim 17, wherein the processor when executing the instructions is further configured for determining a type of media event the recipient is experiencing and based at least in part on the type of media event, establishing the reply.

19. The system of claim 17, wherein the processor when executing the instructions is further configured for analyzing content of the media event to return at least a title of the media event and a time period left remaining to an end of the media event.

20. The system of claim 17, wherein content of the reply apart from a device identification is generated depending on the sender to personalize the reply message based upon the media event and the importance of the attempt to contact.
